(19) United States
(12) Patent Application Publication
(10) Pub. No.: US 2026/0300100 A1
(43) Pub. Date: Oct. 1, 2026

(54) RECOVERING DEEP LEARNING TRAINING

(71) Applicant: INTERNATIONAL BUSINESS MACHINES CORPORATION, Armonk, NY (US)

(72) Inventors: Hui Wang, BEIJING (CN); Yu Mei Dai, Beijing (CN); Xiao Chen Huang, Beijing (CN); Peng Hui Jiang, Beijing (CN); Xiang Yu Xue, Rizhao (CN); Mai Zeng, BEIJING (CN); Wei Li, BEIJING (CN)

(21) Appl. No.: 19/092,616

(22) Filed: Mar. 27, 2025

(51) Int. Cl. G06F 11/14; G06N 3/10

(52) U.S. Cl. CPC G06F 11/1451; G06N 3/10

(57) ABSTRACT

A method, system, and computer program product that is configured to: receive training data from an external application; train a deep learning model at a first server based on the received trained data; save a plurality of checkpoints in an external memory device during the training of the deep learning model; determine that there is an interruption of the training of the deep learning model; resume and complete training of the deep learning model at a second server in response to determining that there the interruption of the training of the deep learning model; and deploy a trained deep learning model in response to completing training of the deep learning model.

### BACKGROUND

Aspects of the present invention relate generally to recovering deep learning training and, more particularly, to recovering deep learning training thru an external memory device.

A deep learning model can take a long time to train. Accordingly, the training process is prone to being interrupted before the training process is complete.

### SUMMARY

In a first aspect of the invention, there is a method including: receiving training data from an external application; training a deep learning model at a first server based on the received trained data; saving a plurality of checkpoints in an external memory device during the training of the deep learning model; determining that there is an interruption of the training of the deep learning model; resuming and completing training of the deep learning model at a second server in response to determining that there is the interruption of the training of the deep learning model; and deploying a trained deep learning model in response to completing the training of the deep learning model.

In another aspect of the invention, there is a computer program product comprising one or more computer-readable storage media and program instructions stored on the one or more computer-readable storage media to perform operations comprising: receiving training data from an external application; training a deep learning model at a first training node based on the received trained data; saving a plurality of checkpoints in an external memory device during the training of the deep learning model; determining that there is an interruption of the training of the deep learning model; resuming and completing the training of the deep learning model at a second training node in response to the determining that there is the interruption of the training of the deep learning model; and deploying a trained deep learning model in response to completing the training of the deep learning model.

In another aspect of the invention, there is a computer system comprising a processor set, one or more computer-readable storage media, and program instructions stored on the one or more computer-readable storage media to cause the processor set to perform operations comprising: receiving training data from an external application; training a deep learning model at a first server based on the received trained data; saving a plurality of checkpoints in an external memory device during the training of the deep learning model; determining that there is an interruption of the training of the deep learning model; resuming and completing training of the deep learning model at a second server in response to determining that there is the interruption of the training of the deep learning model; and deploying a trained deep learning model in response to completing the training of the deep learning model. Further embodiments of the present invention include the first server being different from the second server, and the interruption including an abnormal failure of the first server.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment of a deep learning recovery server in accordance with aspects of the present invention.

FIG. 3 shows a flowchart of an exemplary method of the deep learning recovery server in accordance with aspects of the present invention.

FIG. 4 shows a block diagram of an exemplary environment of a deep learning recovery system in accordance with aspects of the present invention.

FIG. 5 shows another block diagram of an exemplary environment of another deep learning recovery system in accordance with aspects of the present invention.

FIG. 6 shows a flowchart of an exemplary method of the deep learning recovery system in accordance with aspects of the present invention.

FIG. 7 shows a flowchart of another exemplary method of another deep learning recovery system in accordance with aspects of the present invention.

### DETAILED DESCRIPTION

Aspects of the present invention relate generally to recovering deep learning training and, more particularly, to recovering deep learning training thru an external memory device. In embodiments of the present invention, the systems and methods recover a deep learning model training process from an interruption by utilizing an external memory device. In further embodiments, the systems and methods recover the training process by using a separate resource, such as a node, a server, etc. In aspects of the present invention, training process as used herein refers to a process in which the deep learning model is trained.

The method may also include receiving training data from an external application; training a deep learning model at a first server based on the received trained data; saving a plurality of checkpoints in an external memory device during the training of the deep learning model; determining that there is an interruption of the training of the deep learning model; resuming and completing training of the deep learning model at a second server in response to determining that there is the interruption of the training of the deep learning model; and deploying a trained deep learning model in response to completing the training of the deep learning model. In particular, embodiments may improve recovering the deep learning model training process from an interruption by using a separate server for resuming and completing the training process.

The method may also include the external application including a software application. In particular, embodiments may improve recovering the training process by utilizing a software application to send training data to train a deep learning model.

The method may also include the training data including historical training data. In particular, embodiments may improve recovering the training process by utilizing historical training data to train a deep learning model.

The method may also include the first server and the second server including a hardware server. In particular, embodiments may improve recovering the training process by utilizing a hardware server for the first server and the second server.

The method may also include the first server being different from the second server. In particular, embodiments may improve recovering the training process by including the first server which is different from the second server.

The method may also include the interruption including an abnormal failure. In particular, embodiments may improve recovering the training process by including the interruption as an abnormal failure.

The method may also include the abnormal failure including a failure of the first server. In particular, embodiments may improve recovering the training process by including the abnormal failure as a failure of the first server.

The method may also include the external memory device comprises a non-volatile memory device. In particular, embodiments may improve recovering the training process by including the external memory device as a non-volatile memory device.

The method may also include training another model at the second server, and the second server is in a same cluster as the first server. In particular, embodiments may improve recovering the training process by training another model at the second server.

The method may also include the resuming and completing training of the deep learning model at the second server occurs in parallel with the training of the another model at the second server, and the second server and the first server connect to the external memory device. In particular, embodiments may improve recovering the training process by resuming and completing training of the deep learning model in parallel with the training of the another model.

The method may also include pausing the training of the another model at the second server while resuming and completing training of the deep learning model at the second server based on resources of the second server and a priority of the training of the another model at the second server. In particular, embodiments may improve recovering the training process by pausing the training of the another model at the second server while resuming and completing training of the deep learning model at the second server based on resources of the second server and a priority of the training of the another model at the second server.

The method may also include the training data being received at the first server. In particular, embodiments may improve recovering the training process by the training data being received at the first server.

The method may also include the trained deep learning model being deployed from the first server to an external software application. In particular, embodiments may improve recovering a training process by deploying the trained deep learning model to an external software application.

The method may alco include the external software application being external from the first server. In particular, embodiments may improve recovering the training process by the external software application being external from the first server.

In another aspect of the invention, there is a computer program product comprising one or more computer-readable storage media and program instructions stored on the one or more computer-readable storage media to perform operations comprising: receiving training data from an external application; training a deep learning model at a first training node based on the received trained data; saving a plurality of checkpoints in an external memory device during the training of the deep learning model; determining that there is an interruption of the training of the deep learning model; resuming and completing the training of the deep learning model at a second training node in response to the determining that there is the interruption of the training of the deep learning model; and deploying a trained deep learning model in response to completing the training of the deep learning model. In particular, embodiments may improve recovering the training process from an interruption by using a separate server for resuming and completing the training process.

The computer program product may also include the external application including a software application. In particular, embodiments may improve recovering the training process by utilizing a software application to send training data to train a deep learning model.

The computer program product may also include the training data including historical training data. In particular, embodiments may improve recovering the training process by utilizing historical training data to train a deep learning model.

The computer program product may also include the first training node being different from the second training node. In particular, embodiments may improve recovering the training process by including the first training node which is different from the second training node.

The computer program product may also include the external memory device comprises a non-volatile memory device. In particular, embodiments may improve recovering the training process by including the external memory device as a non-volatile memory device, such as a flash memory, hard drive, optical disc, magnetic tape, read-only memory (ROM), ferroelectric RAM (FRAM), electrically erasable programmable read-only memory (EEPROM), etc.

The computer-implemented method may also include the interruption including a failure of the first training node. In particular, embodiments may improve embodiments may improve recovering the training process by including the abnormal failure as a failure of the first server.

In another aspect of the invention, there is a computer system comprising a processor set, one or more computer-readable storage media, and program instructions stored on the one or more computer-readable storage media to cause the processor set to perform operations comprising: receiving training data from an external application; training a deep learning model at a first server based on the received trained data; saving a plurality of checkpoints in an external memory device during the training of the deep learning model; determining that there is an interruption of the training of the deep learning model; resuming and completing training of the deep learning model at a second server in response to determining that there is the interruption of the training of the deep learning model; and deploying a trained deep learning model in response to completing the training of the deep learning model. Further embodiments of the present invention include the first server being different from the second server, and the interruption including an abnormal failure of the first server. In particular, embodiments may improve recovering the training process from an interruption by using a separate server for resuming and completing the training process.

Aspects of the present invention relate to instantaneously recording memory information during the training process and recovering the training process from a stopped point through an external memory device. Embodiments of the present invention record a training intermediate state (i.e., a checkpoint) of a training process in an external memory device. Further embodiments of the present invention recover the training process from the training intermediate state (i.e., the checkpoint) recorded in the external memory device. Further embodiments of the present invention are not limited to a deep learning model, and may be applicable to all machine learning (ML) models which are trained in a computing environment.

Embodiments of the present invention provide a hardware device to achieve high speed access and a storage device for storing model training checkpoint state information. Further embodiments of the present invention frequently record a checkpoint state to cope with unexpected interrupts in an application. Aspects of the present invention utilize a first server to immediately take over a training process from a recorded checkpoint state in an external memory device in response to the training process on a second server being abnormally interrupted. Embodiments of the present invention recover the training process after the first server immediately takes over the training process from the recorded checkpoint state in the external memory device.

Embodiments of the present invention resume and complete model training in response to an interruption of the model training. In contrast, conventional systems typically save the progress of the training system. However, in conventional systems, saving the progress of the training system will consume resources and decrease training speed.

Conventional systems impact training processes across multiple servers or nodes in a cloud training environment in response to an abnormal failure on a single server or node. Embodiments of the present invention utilize a second server and an external memory device to create and save checkpoints and resume training in response to an abnormal failure on a first server. Accordingly, implementations of the present invention avoid consuming resources and decreasing training speed by utilizing the external memory device to save checkpoints. Further, aspects of the present invention prevent impacts to the entire cloud training environment by resuming and completing training using the external memory device and the second server.

Implementations of the invention are necessarily rooted in computer technology. For example, the steps of training a deep learning model at a first server based on received trained data, saving a plurality of checkpoints in an external memory device during the training of the deep learning model, determining that there is an interruption of the training of the deep learning model, and resuming and completing training of the deep learning model at a second server in response to determining that there is the interruption of the training of the deep learning model is computer-based and cannot be performed in the human mind (or with pen and paper). Training a deep learning model at a first server, saving a plurality of checkpoints in an external memory device, determining that there is an interruption of the training, and resuming and completing training of the deep learning model at a second server is, by definition, performed by a computer and cannot practically be performed in the human mind (or with pen and paper). In further embodiments, the step of resuming and completing training of the deep learning model at a second server occurs in parallel with the training of the another model at the second server is also rooted in computer technology and cannot be performed in the human mind (or with pen and paper).

Aspects of the present invention include a method, system, and computer program product for recording memory information during a training process and recovering a training from a stopped point thru an external memory device. For example, a method includes: recording a training intermediate state of memory in an external memory device; and receiving a training process from the recorded intermediate state taken over from the external memory device. In aspects of the present invention, the training intermediate state comprises a checkpoint.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as deep learning recovery code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

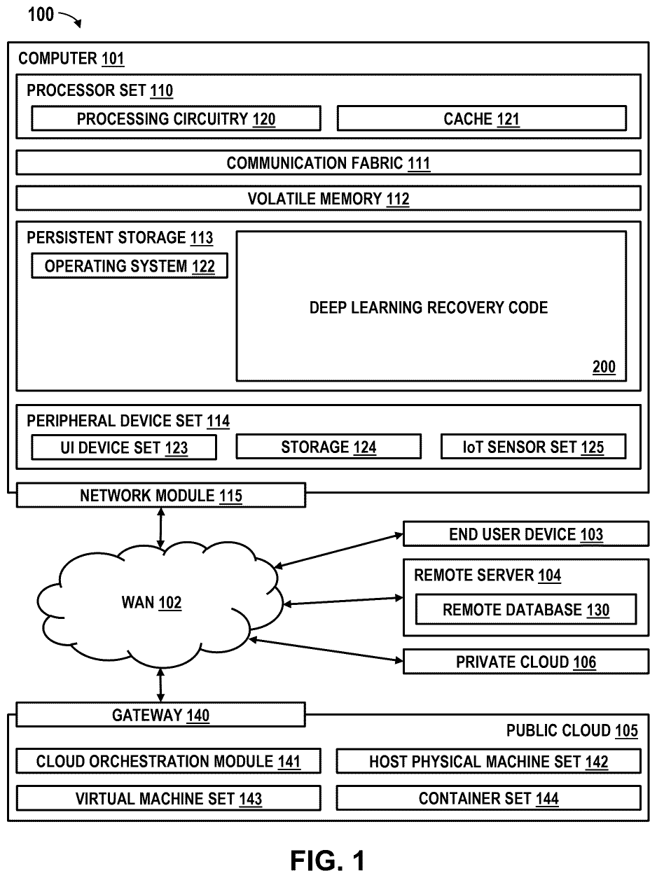

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

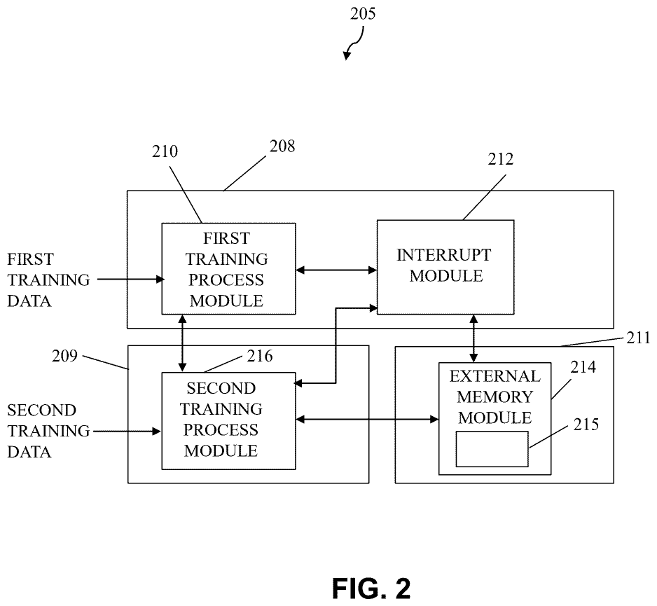

FIG. 2 shows a block diagram of an exemplary environment 205 in accordance with aspects of the invention. In embodiments, the environment 205 includes a deep learning recovery server 208, which may comprise one or more instances of the computer 101 of FIG. 1. In other examples, the deep learning recovery server 208 comprises one or more virtual machines or one or more containers running on one or more instances of the computer 101 of FIG. 1. In further embodiments, an external memory module 214 and a second training process module 216 may be external to the deep learning recovery server 208. In aspects of the present invention, the second training process module 216 may be included in a first external server 209, such as one or more instances of the remote server 104 of FIG. 1. In further embodiments, the first external server 209 is different from the deep learning recovery server 208. In embodiments, the second training process module 216 comprises one or more virtual machines or one or more containers running on one or more instances of the computer 101 of FIG. 1. In aspects of the present invention, the external memory module 214 may be included in a second external server 211, such as one or more instances of the remote server 104 of FIG. 1. In further embodiments, the second external server 211 is different from the deep learning recovery server 208 and the first external server 209. In other embodiments, the external memory module 214 may be included in one of the deep learning recovery server 208 and the first external server 209 (not shown in FIG. 2).

In embodiments, the deep learning recovery server 208 of FIG. 2 comprises a first training process module 210 and an interrupt module 212, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The deep learning recovery server 208 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In FIG. 2, and in accordance with aspects of the invention, the first training process module 210 receives first training data from a first external application. In further embodiments of the present invention, the second training process module 216 receives second training data from a second external application. In embodiments, the first external application comprises a first software application which includes the first training data. In further embodiments, the first training data comprises historical training data associated with the first software application. In aspects of the present invention, the second external application comprises a second software application which includes the second training data. In embodiments, the second training data comprises historical training data associated with the second software application. For example, historical training data comprises historical data which is utilized as a training ground to train a deep learning model using historical patterns and relationships within the historical data.

In embodiments, the first training process module 210 comprises a deep learning model which applies layers by stacking the layers comprising multiple computational units on top of each other within a network architecture. In further embodiments, the deep learning model applies each layer on the first training data to perform a transformation on the first training data to gradually extract complex features and produce a model output.

In embodiments, the first training process module 210 utilizes the deep learning model to train on the first training data by utilizing a deep learning algorithm. In further embodiments, the first training process module 210 saves a plurality of checkpoints during training of the deep learning model. In embodiments of the present invention, application checkpointing (i.e., saving the checkpoints) comprises a fault tolerant technique which allows for quick recovery from abnormal interruptions (e.g., abnormal failures) by reducing an impact of the interruptions and resuming the training from the interruption to finish the training. In aspects of the present invention, an abnormal failure comprises at least one of a power failure, a network issue, a hardware failure, an operating system (OS) fault, a graphics processing unit (GPU) failure, etc. In further embodiments of the present invention, the training process module 210 saves the plurality of checkpoints at a predetermined time period (i.e., every minute, every hour, every 4 hours, every day, etc.) In aspects of the present invention, each of the checkpoints represents a snapshot of a state of the training so that the training can be resumed from the snapshot of the checkpoint in response to a determination that there is an abnormal failure. Accordingly, implementations of the present invention allow the training process to resume in the second training process module 216 in response to detection of the abnormal failure.

In embodiments of the present invention, each of the checkpoints include application details, weights of the deep learning model, what training has been performed, and what training is left to be performed to complete the training. In further embodiments, the deep learning model utilizes the weights of the deep learning model to make current predictions (i.e., as-is predictions) or to make future predictions in ongoing training. In aspects of the present invention, the first training process module 210 saves the checkpoints during training in the external memory module 214. In further aspects of the present invention, the first training process module 210 saves the checkpoints during training in an external memory device 215 of the external memory module 214. In embodiments, the external memory module 214 is a hardware module containing at least one memory hardware circuit for storing data. In further embodiments, the external memory module 214 comprises the external memory device 215 for saving and storing checkpoints. In embodiments of the present invention, the first training process module 210 saves the checkpoints in the external memory device 215 of the external memory module 214 on a frequent schedule (i.e., every minute, every hour, every 4 hours, every day, etc.) to reduce the impact on an unexpected interruption (e.g., an unexpected server failure) and reduce resource consumption within the deep learning recovery server 208. In further embodiments, the external memory device 215 of the external memory module 214 comprises non-volatile memory.

In aspects of the present invention, the external memory device 215 comprises a coupling facility (CF) which includes a mainframe processor with memory, special channels (i.e., CF links), and a specialized operating system (i.e., coupling facility control code (CFCC)). In embodiments, the mainframe processor runs in a logical partition (LPAR) with dedicated physical central processors (CPs) thru a high management console (HMC). In further embodiments, information in the CF resides entirely in physical memory in the CFCC. In aspects of the present invention, the CF has a large memory (i.e., an order of several tens of gigabytes). In embodiments of the present invention, the CF does not include any application software.

In aspects of the present invention, the interrupt module 212 determines that there is an abnormal failure during training of the deep learning model in the first training process module 210. In embodiments of the present invention, the interrupt module 212 monitors the training of the deep learning module in the first training process module 210 to determine that there is the abnormal failure. In further embodiments of the present invention, the interrupt module 212 determines that there is the abnormal failure and sends a notification signal that there is an abnormal failure to the second training process module 216.

In embodiments of the present invention, the second training process module 216 receives the notification signal and communicates with the external memory module 214 to obtain the latest saved checkpoint from the external memory module 214. In further embodiments, the second training process module 216 extracts information regarding the application details, weights of the deep learning model, what training has been performed, and what training is left to be performed in the latest saved checkpoint. In aspects of the present invention, the second training process module 216 uses the extracted information to resume the training of the deep learning model from the snapshot of the checkpoint. In further embodiments of the present invention, the second training process module 216 completes the training of the deep learning model. In some embodiments, the second training process module 216 completes the training of the deep learning model in parallel with training another model using the second training data. In further embodiments, the first external server 209 is in a same cluster as the deep learning recovery server 208. In other embodiments, the second training process module 216 pauses training the another model using the second training data, completes the training of the deep learning model, and then resumes training the another model using the second training data in response to completing training of the deep learning model. In further embodiments, the first external server 209 and the deep learning recovery server 208 are connected to the external memory device. For example, the second training process module 216 may pause training of the another model using the second training data based on computing resources available to the second training process module 216 being below a minimum predetermined threshold and a priority of the training of the another model.

In aspects of the present invention, the second training process module 216 outputs a training complete signal to the first training process module 210 in response to the second training process module 216 completing the training and determining that the first training process module 210 has recovered from the abnormal failure. In embodiments of the present invention, the second training process module 216 waits to output the training complete signal until the first training process module 210 has recovered from the abnormal failure. In further embodiments of the present invention, the second training process module 216 then sends the completely trained deep learning model to the first training process module 210 after outputting the training complete signal to the first training process module 210. In this situation, the first training process module 210 deploys the trained deep learning model for use by software applications. In other embodiments, the second training process module 216 sends the training complete signal to an external application outside of the deep learning recovery server 208. In this situation, the second training process module 216 deploys the trained deep learning model for use by external software applications, which are external to the deep learning recovery server 208.

In a first exemplary use case, the first training process module 210 implements the plurality of checkpoints using callback functions in KERAS™. In the first exemplary use case, KERAS is a python-based framework which is used to build and train neural networks for machine learning and artificial intelligence. In the first exemplary use case, python is a high-level, general-purpose programming language which emphasizes code readability. In the first exemplary use case, the first training process module 210 customizes a behavior of a KERAS model during training by utilizing the callback functions. In the first exemplary use case, the first training process module 210 utilizes TENSORFLOW™ (i.e., tf) to implement the checkpoints using KERAS only (i.e., TF.KERAS, which is a TENSORFLOW implementation of the KERAS model). In the first exemplary use case, TENSORFLOW comprises a software library which is used for training and inference of deep learning frameworks within machine learning and artificial intelligence.

In the first exemplary use case, the first training process module 210 implements the plurality of checkpoints to determine internal statistics of the deep learning model during training, regularly saves progress of training the deep learning model, stops and evaluates the deep learning model, etc. For example, in the first exemplary use case, the first training process module 210 creates checkpoints using the function ModelCheckpoint callback. In particular, the ModelCheckpoint callback calls a ModelCheckpoint( ) method and passes the ModelCheckpoint( ) method during training to a .fit( ) function. In addition, the ModelCheckpoint( ) method is passed to .evaluate( ) and .predict( ) functions of the deep learning model and saves weights of the deep learning model after a predetermined frequency. In embodiments, the first training process module 210 determines the predetermined frequency based on input from a coding user.

In the first exemplary use case, the first training process module 210 creates the checkpoint using the function ModelCheckpoint( ) and external memory structure parameters as shown below in a first example code:
Checkpoint_create=tf.keras.callbacks.ModelCheckpoint (
   structure=‘keras_structure_1’,
   monitor=‘val_loss’,
   verbose=1,
   save_best_only=False,
   mode=‘auto’,
   save_freq=‘epoch’,
   period=1)

### First Example Code

In the first example code above, the line “structure=‘keras_structure_1’ represents the external memory structure parameters.

In a second exemplary use case, the first training process module 210 utilizes a PYTORCH™ training process to describe a training intermediate state and saving the training intermediate state in the external memory device 215 of the external memory module 214. In embodiments, PYTORCH comprises an open-source machine learning library which provides tools and functionalities for building and training deep learning networks. In particular, the first training process module 210 utilizes the PYTORCH training process as shown below in a second example code:
N_epochs=100
loader=DataLoader(trainset, shuffle=True, batch_size=320)
X_test, y_test=default_collate(testset)
loss_fn=nn.BCELoss( )
optimizer=optim. SGD(model. parameters( ), lr=0.1)
for epoch in range (n_epochs)
   model.train( )
   for X_batch, y_batch in loader:
      y_pred=model(X_batch)
      loss=loss_fn(y_pred, y_batch)
      optimizer.zero_grad( )
      loss.backward( )
      optimizer.step( )
   model.eval( )
   y_pred=model(X_test)
   acc=(y_pred. round( )==y_test).float( ).mean( )
   print(f“nd of epoch {epoch}: accuracy={float(acc)*100:.2f}%”)

### Second Example Code

In embodiments, the first training process module 210 utilizes the PYTORCH training process in the second example code above and adds checkpoints to the training loop. In particular, the first training process module 210 utilizes the PYTORCH training process with added checkpoints as shown below in a third example code:
. . .
for epoch in range (n_epochs)
   model.train( )
   for X_batch, y_batch in loader:
      y_pred=model(X_batch)
      loss=loss_fn(y_pred, y_batch)
      optimizer.zero_grad( )
      loss.backward( )
      optimizer.step( )
   model.eval( )
   y_pred=model(X_test)
   acc=(y_pred.round( )==y_test).float( ).mean( )
   print(f“nd of epoch {epoch}: accuracy={float(acc)*100:.2f}%”)
   checkpoint(model, f“ tructure-{epoch}.str”)

### Third Example Code

In the third example code above, the line “checkpoint(model, f“structure-{epoch}.str”)” checkpoints the deep learning model from an epoch n into the external memory structure structure-n.str. In this situation, each external memory structure includes a pickled model weight. In aspects of the present invention, pickling is a process of converting a python object hierarchy into a byte stream. Accordingly, the first training process module 210 can create the checkpoint in a frequent predetermined time period (i.e., every minute, every hour, every 4 hours, every day, etc.).

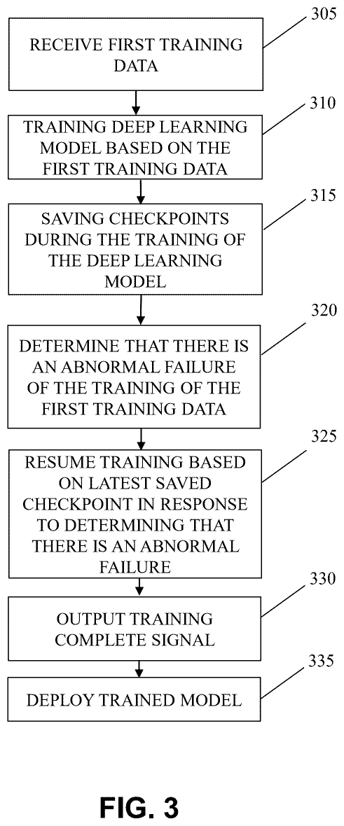

FIG. 3 shows a flowchart of an exemplary method of the deep learning recovery server in accordance with aspects of the present invention. Steps of the method may be carried out in the environment of FIG. 2 and are described with reference to elements depicted in FIG. 2.

At step 305, the system receives, at the first training process module 210, first training data from a first external application. In embodiments and as described with respect to FIG. 2, the first training data comprises historical training data. At step 310, the system trains, at the first training process module 210, a deep learning model based on the first training data. At step 315, the system saves, at the first training process module 210, a plurality of checkpoints during the training of the deep learning model. In embodiments and as described with respect to FIG. 2, the first training process module 210 saves the plurality of checkpoints in the external memory 215 device of the external memory module 214.

At step 320, the system determines, at the interrupt module 212, that there is an abnormal failure during training of the deep learning model in the first training process module 210. In embodiments and as described with respect to FIG. 2, the interrupt module 212 sends a notification signal that there is an abnormal failure to the second training process module 216 in response to a determination that there is an abnormal failure during the training of the deep learning model. At step 325, the system resumes and completes, at the second training process module 216, training of the deep learning model based on a latest saved checkpoint in the external memory module 214 in response to receiving the notification signal.

At step 330, the system outputs, at the execution module 214, a training complete signal to the first training process module 210 in response to the second training process module 216 completing the training and determining that the second training process module 216 has recovered from the abnormal failure. At step 335, the system deploys, at the first training process module 210, the trained deep learning model for use by software applications in response to receiving the training complete signal.

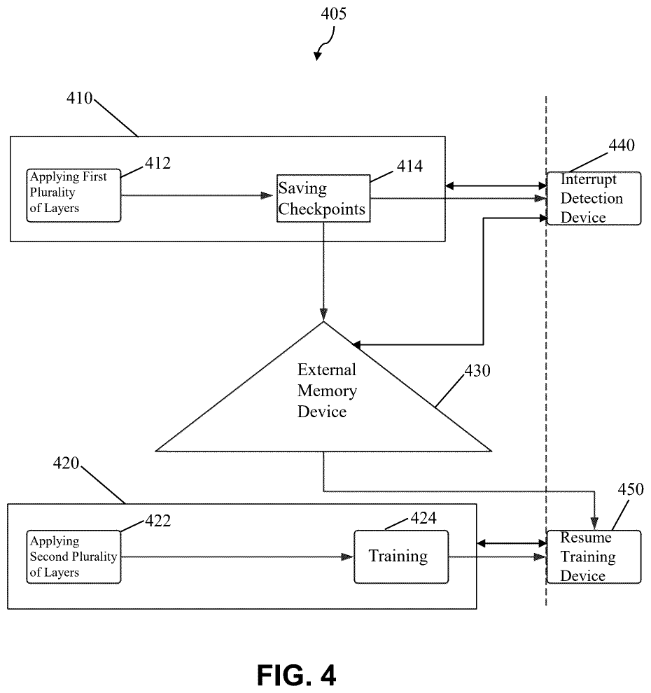

FIG. 4 shows a block diagram of an exemplary environment of a deep learning recovery system in accordance with aspects of the present invention. In particular, the deep learning recovery system 405 comprises a first hardware server 410 (corresponding to the deep learning recovery server 208 in FIG. 2), a second hardware server 420 (corresponding to the first external server 209 in FIG. 2), an external memory device 430 (corresponding to the external memory device 215 in FIG. 2), and an interrupt detection device 440 (corresponding to the interrupt module 212 in FIG. 2). In embodiments, the first hardware server 410 comprises a deep learning model which applies a first plurality of layers 412 by stacking the layers comprising multiple computation units on top of each within the deep learning recovery system 405. In further embodiments, the second hardware server 420 comprises another model which applies a second plurality of layers 422 by stacking the layers comprising multiple computation units on top of each within the deep learning recovery system 405.

In further embodiments, the first hardware server 410 trains the deep learning model and saves a plurality of checkpoints 414 into an external memory device 430 during the training of the deep learning model. In aspects of the present invention, the second hardware server 420 performs training 424 of another model.

In aspects of the present invention, the interrupt detection device 440 determines that there is an abnormal failure during training of the deep learning model in the first hardware server 410. In embodiments, the interruption detection device 440 sends a notification interruption signal to the external memory device 430. In further embodiments, the external memory device 430 sends a resume training signal and a latest saved checkpoint to a resume training device 450.

In aspects of the present invention, the resume training device 450 communicates with the second hardware server 420 to resume training at the second hardware server 420 of the deep learning model. In embodiments, the second hardware server 420 resumes and completes training of the deep learning model in parallel with training 424 another model. The second hardware server 420 sends the trained deep learning model to the first hardware server 410. The first hardware server 410 deploys the trained deep learning model to software applications.

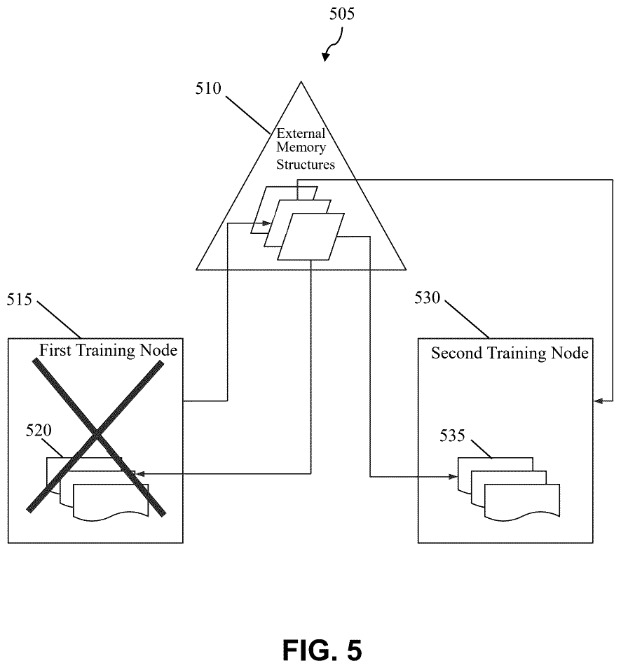

FIG. 5 shows another block diagram of an exemplary environment of another deep learning recovery system in accordance with aspects of the present invention. In embodiments, another deep learning recovery system 505 in FIG. 5 comprises external memory structures 510 (corresponding to the external memory device 215 in FIG. 2), a first training node 515 (corresponding to the deep learning recovery server 208 in FIG. 2) comprising a first memory with a first set of checkpoints 520, and a second training node 530 (corresponding to the first external server 209) comprising a second memory with a second set of checkpoints 535.

In embodiments, the first training node 515 trains a deep learning model with training data. In further embodiments, the first training node 515 saves the first set of checkpoints 520 in the first memory and the external memory structures 510. Accordingly, as shown in FIG. 5, the first training node 515 encounters an abnormal failure (as indicated by the “X”). In this scenario, the external memory structures 510 determines that there is no communication with the first training node 515 and sends a notification signal and a latest checkpoint of the first set of checkpoints 520 to the second training node 530.

In aspects of the present invention, the second training node 530 resumes and completes training of the deep learning model in response to receiving the notification signal and the latest checkpoint of the first set of checkpoints 520. The second training node 530 sends a training complete signal and the trained deep learning model to the external memory structures 510 in response to completing the training of the deep learning model. The external memory structures 510 sends the training complete signal and the trained deep learning model to the first training node 515 in response to the external memory structures 510 determining that there is communication with the first training node 515 (i.e., no abnormal failure). In embodiments, the first training node 515 deploys the trained deep learning model to software applications.

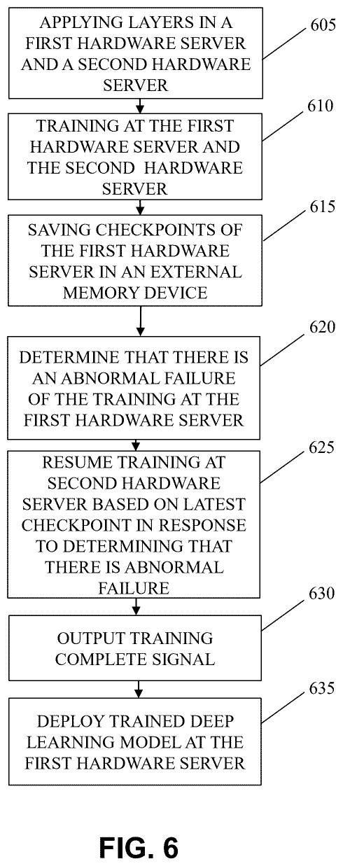

FIG. 6 shows a flowchart of another exemplary method of the memory auto tuning server in accordance with aspects of the present invention. Steps of the method may be carried out in the environment of FIG. 4 and are described with reference to elements depicted in FIG. 4.

At step 605, the system applies, at the first hardware server 410 and the second hardware server 420, a first plurality of layers 412 and a second plurality of layers 422, respectively. At step 610, the system trains, at the first hardware server 410 and the second hardware server 420, the deep learning model and another model, respectively. At step 615, the system saves, at the external memory device 430, a plurality of checkpoints during training of the deep learning model at the first hardware server 410.

At step 620, the system determines, at the first hardware server 410, that there is an interruption (e.g., abnormal failure) of the training at the first hardware server 410. At step 625, the system resumes and completes, at the second hardware server 420, training at the second hardware server 420 based on a latest checkpoint of the checkpoints in response to determining that there is an interruption (e.g., abnormal failure) of the training at the first hardware server 410.

At step 630, the system outputs, at the second hardware server 420, a training complete signal based on a completion of the training at the second hardware server 420. At step 635, the system deploys, at the second hardware server 420, the trained deep learning model. In embodiments and as described with FIG. 4, the second hardware server 420 sends the trained deep learning model to the first hardware server 410 for deployment.

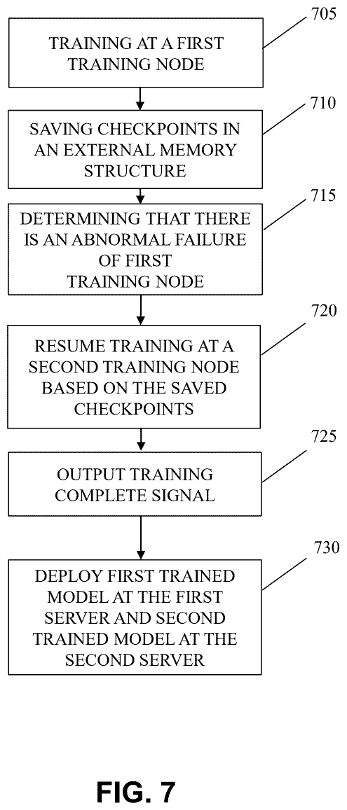

FIG. 7 shows a flowchart of another exemplary method of the memory auto tuning server in accordance with aspects of the present invention. Steps of the method may be carried out in the environment of FIG. 5 and are described with reference to elements depicted in FIG. 5.

At step 705, the system trains, at the first training node 515, a deep learning model. At step 710, the system saves, at the first training node 515, a plurality of checkpoints in external memory structures 510. At step 715, the system determines, at the external memory structures 510, that there is an abnormal failure at the first training node 515.

At step 720, the system resumes and completes, at the second training node 530, training of the deep learning model using a latest checkpoint of the plurality of checkpoints. At step 725, the system outputs, at the second training node 530, a training complete signal based on a completion of the training at the second training node 530. At step 730, the system deploys, at the fist training node 515, the trained deep learning model. In embodiments and as described with FIG. 5, the second training node 530 sends the trained deep learning model to the first training node 515 for deployment.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving training data from an external application;
training a deep learning model at a first server based on the received trained data;
saving a plurality of checkpoints in an external memory device during the training of the deep learning model;
determining that there is an interruption of the training of the deep learning model;
resuming and completing training of the deep learning model at a second server in response to determining that there is the interruption of the training of the deep learning model; and
deploying a trained deep learning model in response to completing the training of the deep learning model.

2. The method of claim 1, wherein the external application comprises a software application.

3. The method of claim 1, wherein the training data comprises historical training data.

4. The method of claim 1, wherein the first server and the second server each comprise a respective hardware server.

5. The method of claim 1, wherein the first server is different from the second server.

6. The method of claim 1, wherein the interruption comprises an abnormal failure.

7. The method of claim 6, wherein the abnormal failure comprises a failure of the first server.

8. The method of claim 1, wherein the external memory device comprises a non-volatile memory device.

9. The method of claim 1, further comprising training another model at the second server, wherein the second server is in a same cluster as the first server.

10. The method of claim 9, wherein the resuming and completing training of the deep learning model at the second server occurs in parallel with the training of the another model at the second server, and the second server and the first server connect to the external memory device.

11. The method of claim 9, further comprising pausing the training of the another model at the second server while resuming and completing training of the deep learning model at the second server based on resources of the second server and a priority of the training of the another model at the second server.

12. The method of claim 1, wherein the training data is received at the first server.

13. The method of claim 1, wherein the trained deep learning model is deployed from the first server to an external software application.

14. The method of claim 13, wherein the external software application is external from the first server.

15. A computer program product comprising:
one or more computer-readable storage media; and
program instructions stored on the one or more computer-readable storage media to perform operations comprising:
receiving training data from an external application;
training a deep learning model at a first training node based on the received trained data;
saving a plurality of checkpoints in an external memory device during the training of the deep learning model;
determining that there is an interruption of the training of the deep learning model;
resuming and completing training of the deep learning model at a second training node in response to determining that there is the interruption of the training of the deep learning model; and
deploying a trained deep learning model in response to completing the training of the deep learning model.

16. The computer program product of claim 15, wherein the external application comprises a software application.

17. The computer program product of claim 15, wherein the training data comprises historical training data.

18. The computer program product of claim 15, wherein the first training node is different from the second training node.

19. The computer program product of claim 15, wherein the external memory device comprises a non-volatile memory device, and the interruption comprises a failure of the first training node.

20. A computer system comprising:
a processor set;
one or more computer-readable storage media; and
program instructions stored on the one or more computer-readable storage media to cause the processor set to perform operations comprising:
receiving training data from an external application;
training a deep learning model at a first server based on the received trained data;
saving a plurality of checkpoints in an external memory device during the training of the deep learning model;
determining that there is an interruption of the training of the deep learning model;
resuming and completing training of the deep learning model at a second server in response to determining that there is the interruption of the training of the deep learning model; and
deploying a trained deep learning model in response to completing the training of the deep learning model,
wherein the first server is different from the second server, and the interruption comprises an abnormal failure of the first server.
